(19) United States
(12) Patent Application Publication
(10) Pub. No.: US 2007/0008949 A1
(43) Pub. Date: Jan. 11, 2007

(54) Method for automatic route aggregation in a communication system

(75) Inventor: Sergey Balandin, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/175,477

(22) Filed: Jul. 7, 2005

(51) Int. Cl. H04L 12/28; H04L 12/56

(52) U.S. Cl. 370/351; 370/401

(57) ABSTRACT

The invention relates to a method for automatic route aggregation in a communication system. Routes are aggregated in area boundary or equivalently in edge routers. The edge routers calculate most specific route aggregation solutions based on route information received from subordinate routers. The route aggregation solutions are provided to a master edge router, which performs further route aggregation based on information from all edge routers. The master edge router performs also route combination avoiding routing conflicts. The master edge router provides the resulting route aggregates to the other edge routers. The edge routers advertise the resultant route aggregates to an upper-level network.

### BACKGROUND OF THE INVENTION

1. Field of the Invention

The invention relates to routing in communication systems. Particularly, the invention relates to a method for automatic route aggregation in a communication system.

2. Description of the Related Art

Originally, the Internet Protocol (IP) address space was allocated for service providers in fixed size blocks that belonged to one of three categories. The categories were denoted as A, B and C, which had the respective sizes of 16777216, 65534 and 254 addresses. As early as 1993 it became evident that the original IP address allocation scheme was improvident and that the depletion of class B addresses was awaiting in the near future. The utilization level of class B address blocks was also far from being optimal. In many cases most of the addresses were actually unused by the organization to which the block was allocated. Further, it was anticipated that the routing table sizes might grow beyond the capabilities of the routers available at that time. It was considered not possible to have routing table entries for myriads of class C networks.

As the remedy for the depletion of addresses and the exponential growth of the routing table sizes a solution called Classless Inter-Domain Routing (CIDR) was introduced. The CIDR is disclosed in Internet Engineering Task Force (IETF) documents RFC 1519 and RFC 1518. The CIDR is supported by the Open Shortest Path First (OSPF) v2 protocol, which is disclosed in IETF document RFC 2328. The CIDR is also supported by such protocols as Routing Information Protocol (RIP) v2 protocol and Border Gateway Protocol (BGP) v4. In CIDR an IP address is divided in two parts a head and a tail. The head is a prefix, which points to a given subnet. The tail points to a given host within the subnet. The prefix part is indicated with a network mask, which accompanies an IP address. A logical and operation is performed between the IP address and the network mask to obtain the prefix. In the CIDR there may be multiple subnets that match a given IP address. The subnets are distinguished from one another using the network mask in addition to an IP address.

In the CIDR two rules are defined. The first rule states that routing to all destinations must be performed on a longest-match basis. The second rule states that a routing domain, which performs summarization of multiple routes, must discard packets that match the summarization but do not match any of the explicit routes comprised in the summarization. The purpose of the second rule is to prevent routing loops that emerge if a packet re-routed upwards in the absence of a matching explicit route.

Reference is now made to FIG. 1, which illustrates a communication system supporting the Classless Inter-Domain Routing (CIDR) in prior art. In FIG. 1 there is shown a backbone network 100. Backbone 100 is identified with an IP address and network mask pair wherein the IP address is 172.128.0.0 and the network mask is 255.255.0.0. The short hand notation for the network mask 255.255.0.0 is “/16”. The number following the slash indicates the number of leading binary digits “1” in the network mask. To backbone 100 are connected two service provider networks, namely networks 110 and 120. There are five client networks, namely networks 130, 140, 150, 160 and 170. Either network 110 or 120 serves a client network. It is also possible that a client network is multi-homed, which means that both networks may serve it in turn or simultaneously for outbound traffic originating from the client network. There may be load sharing between networks 110 and 120 for the outbound traffic. Inbound traffic to the client network must be routed via either network 110 or 120 at a given moment in time unless backbone 100 does not perform load sharing between networks 110 and 120. Therefore, either network 110 or 120 must advertise the route for the client network. In FIG. 1 to network 110 are connected client networks 130, 140 and 160. To network 120 are connected client networks 140, 150, 160 and 170. Client networks 140 and 160 are multi-homed. Client network 150 has originally been served by network 110, but is now served by network 120 and is exclusively connected to it.

In FIG. 1 route advertisements for networks 110 and 120 are 111 and 121, respectively. The route advertisements for client networks 130, 140, 150, 160 and 170 are 131, 141, 151, 161 and 171, respectively. Because inbound traffic to client network 140 is to be routed via network 110 despite the fact that client network 140 belongs to the address space of network 120, route advertisement 141 for client network 140 must be provided by network 110 to backbone 100. Similarly, because inbound traffic to client network 160 is to be routed via network 120 despite the fact that client network 160 belongs to the address space of network 110, route advertisement 161 for client network 160 must be provided by network 110 to backbone 100. Further, client network 150 also belongs to the address space of network 110 despite the fact that it has changed to be connected to network 120 exclusively. Therefore, network 120 must provide route advertisement 151 to backbone 100. To summarize, network 110 must provide route advertisements 111 and 141 to backbone 100, whereas network 120 must provide route advertisements 121, 151 and 161 to backbone 100.

Reference is now made to FIG. 2, which illustrates the IP addresses and network masks for the different networks illustrated in FIG. 1 in prior art. In FIG. 2 there is a table 200, which comprises an entry for each network. A first field 212 in a first row 210 of an entry illustrates the network name, the second field 214 the IP address and the third field 216 denotes the network mask. A second row 220 illustrates the IP address in binary. A third row illustrates the corresponding network mask in binary. The first and the second bits of the third binary number from the left indicate the service provider network and the associated address space. Note that a client network may be advertised from a different service provider network. The advertisement causes that a more specific route is defined to the edge router connected to the service provider network. Due to the first rule of the CIDR an inbound packet is matched to the most specific network mask. The third and the fourth bits of the third binary number from the left indicate the client network. In FIG. 2 the bits indicating the service provider network are separated from the bits indicating the client network using a vertical bar.

Reference is now made to FIG. 3, which illustrates an Autonomous System executing the Open Shortest Path First (OSPF) v2 protocol in prior art. First, the symbols used in FIG. 3 are discussed. In FIG. 3 there are a number of routers such as router 301. OSPF areas are illustrated with boxes such as box 302. Intra-area transit networks are illustrated with ovals such as oval 303. Stub networks and broadcast networks are illustrated with a line such as line 304. Such networks may be, for example, Ethernets or wireless local area networks. An intra-area transit network may also be an Ethernet, other broadcast network or a Non-Broadcast Multi-Access (NBMA) network. An example of a NBMA network is an Asynchronous Transfer Mode (ATM) network or an X.25 network. As illustrated with line 308, in some cases an Ethernet or other broadcast network may be used to connect a number of routers. Point-to-point networks are illustrated with lines such as line 305. Networks are connected to routers with interfaces as illustrated with line 307. A given router may have multiple interfaces, each to a different network. As an aside, in some cases there may be multiple interfaces to a single network, but they may be treated as a single interface from the OSPF point of view. Each interface has associated with it a cost, which represents the cost of transmitting a packet from a router via the interface to a network. In FIG. 3 the costs are illustrated with a number in close proximity to the associated interface. In the case of point-to-point networks the cost for transmitting a packet from a router, for example router RT0E, over the link to the other end is illustrated with a number, such as “5”, in close proximity to the symbol for that router. The only egress direction costs are summed as path length is calculated. An OSPF adjacency relationship between routers is illustrated with dashed lines such as line 306.

In FIG. 3 there is an Autonomous System (AS) 300, which is connected to three other autonomous systems, namely N15, N16 and N17. The autonomous systems N15, N16 and N17 represent high-level networks that are operated by different network operators. AS 300 in FIG. 3 comprises altogether five areas of which only areas 1-4 are explicitly shown. The routers outside areas 1-4 are considered to belong to a backbone area, which is always area 0 in OSPF. The backbone area, that is, area 0 comprises routers RT0A, RT0B, RT0C, RT0E, RT01, RT02, RT0D, RT04A, RT04B and RT23. Routers RT0A, RT0B and RT0C are AS boundary routers for autonomous systems N15, N16 and N17, respectively. An AS boundary router exchanges routing information with another autonomous system, for example, using BGP. Point-to-point networks are defined between router pairs RT01 and RT0D, RT02 and RT0D, RT0E and RT0D, RT04A and RT0D, RT04B and RT04B. There is also a transit broadcast network connecting routers RT0A, RT0B, RT0C and RT0E.

RT01 acts as an area boundary router for area 1 and provides an interface to network N1. RT02 acts as an area boundary router for area 2 and provides an interface to network N5. RT04A and RT04B act as area boundary routers for area 4 and provide interfaces to network N8. RT23 acts as an area boundary router for area 3, which is made possible by defining a virtual link between RT02 and RT23. The virtual link joins RT23 to the backbone. Area 1 comprises networks N1, N2 and N3. Routers RT11 and RT12 provide interfaces to stub networks N1 and N2. They also provide interfaces to network N2. Area 2 comprises networks N4 and N5. Router RT21 provides interfaces to network N4 and N5. Area 3 comprises networks N6 and N7. Router RT31 provides interfaces to networks N6 and N7. Area 4 comprises networks N8-N14. N8 enables alternative access to area 4 either via RT04A or RT04B. Routers RT41, RT42, RT44, RT45, RT46 and RT43 connect networks N8, N10, N11, N12, N13 and N14, respectively, to transit network N9.

The OSPF protocol works in two phases. The first phase is a Hello protocol, which is used to establish and maintain neighbor relationships. On broadcast networks the Hello protocol is used to discover neighboring routers with the aid of IP multicasting. The Hello protocol is also used to elect a designated router and a backup designated router for a broadcast or NBMA network. An adjacency relationship in a given network is established, for example, between a designated router and all other routers in the network, which have active interfaces to other networks. For example, in FIG. 3 an adjacency is established between RT41 and the rest of the routers having an interface to network N9, namely routers RT42, RT44, RT45, RT46 and RT43. The second phase is flooding, during which link-state databases are distributed and synchronized between OSPF routers. The flooding exchange is performed only between routers that are adjacent, which reduces the network capacity consumption significantly. The network capacity is spared further by performing first an exchange of database description packets between adjacent routers, which list Link State Advertisement (LSA) headers pertaining to each LSA held by the sending router in its LSA database. By inspecting the LSA headers the receiving router is capable of determining, which LSAs it should request from the sending router. The LSAs requested are either never versions of existing LSAs or LSAs that have completely been missing previously from the link-state database of the receiving router.

In OSPF information concerning topology of AS 300 is conveyed in the form of Link State Advertisements (LSA), which are exchanged between routers. There are five basic type of link state advertisements: a router-LSA, a network-LSA, a type 3 summary-LSA, a type 4 summary-LSA and an AS external-LSA. All routers originate a router-LSA. The router-LSA describes the interfaces that the router has and thereby the networks to which the router is connected. A network-LSA contains the list of all routers connected to the network. A router-LSA and a network-LSA is only flooded within a single area. Area boundary routers originate both types of summary-LSAs. A summary-LSA describes a route to a destination outside the area. Type 3 summary-LSAs describe routes to networks, whereas type 4 summary-LSAs describer routes to AS boundary routers. Autonomous System (AS) external LSAs are originated by AS boundary routers. They describe routes to destinations in other autonomous systems. An area boundary router forms a type 3 summary-LSA for each network belonging to its area. These summary-LSAs are then transmitted to the backbone, that is area 0. Similarly, as an area boundary router receives a summary-LSA from another area boundary router via the backbone, the receiving area boundary router transmits the summary-LSA to its area.

The LSAs stored in the link-state database of a router are used to assemble its view of the topology of the autonomous system. The topology is a network type-of data structure. Using the Djikstra's algorithm from the network type-of data structure is constructed a shortest-path tree data structure, in which the router is the root node and the other routers and networks are other nodes. The nodes are connected with edges, which represent interfaces from routers to networks or point-to-point networks. Each edge has associated with it a cost. From the shortest-path tree data structure, the router generates its routing table. The routing table specifies as columns the type of destination, which is a router or a network, the destination, which comprises IP address or OSPF router ID in addition to a network mask, area identifier, path type, which is intra-area, inter-area or external, the total cost to reach the destination, next hop and the advertising router ID.

An area border router runs two instances of the OSPF algorithm. There are separate link-state databases for each area attached. The shortest paths are calculated separately for each area attached. All routers belonging to a given area have identical link-state databases.

An area may be configured as a stub area in which case the destinations to the area are grouped to a single route when advertised with a summary-LSA outside the area. The cost to all destinations in the stub area is the same.

One of the factors that limit growth of the Open Shortest Path First (OSPF) routing domains is size of the routing tables and link-state databases. The most straightforward solution of this problem is to use route aggregation that allows an upper level router to not store information about the individual lower level destinations, but instead to have a single route aggregate, which represents all of them. However, the static specification of the route aggregates is not a preferred solution, as it leads to routing errors in a case where a failure occurs in the lower network, and some of the aggregated destinations should be served via another path. Another example is reallocation of the destination to another zone served by another upper level router.

The existing route aggregation solutions, of which the most well known is CIDR allow to serve such destinations as an exception routes, which are not aggregated by using principle of the most specific routing. However, that solution is quite expensive and results in total loss of route aggregation gain when the network nodes have considerable motion freedom, or the network is subject to frequent topology changes due to another reason such as link and router failures, addition of new network hardware and thereupon the definition of new routes. Therefore, there is a need for a mechanism that allows the performing of automatic route aggregation, which takes into account current network conditions.

### SUMMARY OF THE INVENTION

The invention relates to a method for automatic route aggregation in a communication system comprising at least a first area comprising at least one network, a second area comprising at least one network, a first edge router having an interface to both the first area and the second area, and a second edge router having an interface to both the first area and the second area. The method comprises: obtaining information on at least two first routes each associated with a destination in the second area to the first edge router; obtaining information on at least two second routes each associated with a destination in the second area to the second edge router; determining in the first edge router at least one first route aggregate, which covers destinations in the at least two first routes and the address space utilization level of which reaches a predefined threshold; determining in the second edge router at least one second route aggregate, which covers destinations in the at least two second routes and the address space utilization level of which reaches a predefined threshold; obtaining in one of the first edge router and the second edge router information on both the at least one first route aggregate and the at least one second route aggregate; determining in one of the first edge router and the second edge router at least one third route aggregate, the address space utilization level of which reaches a predefined threshold; combining, in one of the first edge router and the second edge router, at least two route aggregates from the at least one first route aggregate, the at least one second route aggregate and the at least one third route aggregate to produce at least one fourth route aggregate; and forming a routing table in the first area by means of information on the at least one fourth route aggregate.

The invention relates also to a system comprising: a first edge router configured to obtain information on at least two first routes each associated with a destination in a second area, to determine at least one first route aggregate, which covers destinations in the at least two first routes and the address space utilization level of which reaches a predefined threshold; a second edge router configured to obtain information on at least two second routes each associated with a destination in a second area, to determine at least one second route aggregate, which covers destinations in the at least two second routes and the address space utilization level of which reaches a predefined threshold; a master edge router configured to obtain information on both the at least one first route aggregate and the at least one second route aggregate, to determine at least one third route aggregate, the address space utilization level of which reaches a predefined threshold, to combine at least two route aggregates from the at least one first route aggregate, the at least one second route aggregate and the at least one third route aggregate to produce at least one fourth route aggregate; and to advertise in the first area information on the at least one fourth route aggregate.

The invention relates also to a router comprising: an input port; an output port; a memory connected to the input port and the output port; and a processor configured to obtain information on at least two first routes each associated with a destination in a second area, to determine at least one first route aggregate, which covers destinations in the at least two first routes and the address space utilization level of which reaches a predefined threshold, to obtain information on the at least one first route aggregate and at least one second route aggregate, to determine at least one third route aggregate, the address space utilization level of which reaches a predefined threshold, to combine at least two route aggregates from the at least one first route aggregate, the at least one second route aggregate and the at least one third route aggregate to produce at least one fourth route aggregate, and to advertise in a first area information on the at least one fourth route aggregate.

The invention relates also to a computer program comprising code adapted to perform the following steps when executed on a data-processing system: obtaining information on at least two first routes each associated with a destination in a second area; determining at least one first route aggregate, which covers destinations in the at least two first routes and the address space utilization level of which reaches a predefined threshold; obtaining information on the at least one first route aggregate and at least one second route aggregate; determining at least one third route aggregate, the address space utilization level of which reaches a predefined threshold; combining at least two route aggregates from the at least one first route aggregate, the at least one second route aggregate and the at least one third route aggregate to produce at least one fourth route aggregate; and advertising in a first area information on the at least one fourth route aggregate.

In one embodiment of the invention, a link-state advertisement is received in the first edge router on a first route; information is transmitted between the first edge router and the second edge router on the at least one fourth route aggregate; and information is advertised on the at least one fourth route aggregate in the first area.

In one embodiment of the invention, in one of the first edge router and the second edge router is determined at least one third route aggregate, the address space utilization level of which reaches a predefined threshold by excluding from the address space of the at least one third route aggregate at least one route aggregate belonging to of the at least one first route aggregate and the at least one second route aggregate. In one embodiment of the invention, this is performed in a master router, which may be one of the first edge router and the second edge router.

In one embodiment of the invention, the system further comprises: the master router configured to indicate support for automatic route aggregation, to determine that the master router has an interface to the second area, to determine that the first edge router and the second edge router have an interface to the second area, to establish adjacency relationships from the master router to the first edge router and the second edge router and to exchange information on at least one route aggregate with the first edge router and the second edge router associated with the adjacency relationships; the first edge router configured to determine that the first edge router has an interface to the second area, to indicate support for automatic route aggregation and that the first edge router has an interface to the second area to the master router, to establish an adjacency relationship with the master router and to exchange information on at least one route aggregate with the master router associated with the adjacency relationship; and the second edge router configured to determine that the second edge router has an interface to the second area, to indicate support for automatic route aggregation and that the second edge router has an interface to the second area to the master router, to establish an adjacency relationship with the master router and to exchange information on at least one route aggregate with the master router associated with the adjacency relationship.

In one embodiment of the invention, the adjacency relationship is established using IP multicast performed in the first area. In the adjacency relationship the master router knows the IP unicast address of the first and the second edge routers and the first and the second edge routers know the IP unicast address of the master router.

In one embodiment of the invention, the predefined threshold is more than half of the address space. In one embodiment of the invention, a stub network is considered to have full address space utilization level. In other words, all addresses belonging to the stub network are considered to be in use. In one embodiment of the invention, a stub network may also comprise a number of routers and networks, and it is connected via an interface to a router, which connects to a transit network. The stub network is considered as a stub from the method point of view, because it is considered from Dynamic Host Configuration Protocol (DHCP) point of view as a single undividable address space. Such an address space is considered always to be full for the purposes of this invention.

In one embodiment of the invention, the communication system comprises a packet switched communication system.

In one embodiment of the invention, the destinations and the route aggregates are specified with a network address and a network mask. In one embodiment of the invention, the destinations and the route aggregates are specified with an IPv6 address prefix and the prefix length.

In one embodiment of the invention, the communication system transmits Internet Protocol (IP) packets. The routers are IP routers. In one embodiment of the invention, the packets are IPv4 packets. In one embodiment of the invention, the packets are IPv4 packets.

In one embodiment of the invention, the second area comprises an Open Shortest Path First OSPF area. The second area may be an area connected to the OSPF backbone, that is, an area with identifier other than 0. The first area may be the OSPF backbone.

In one embodiment of the invention, the first area comprises an autonomous system different from the autonomous system to which the second area belongs.

In one embodiment of the invention, the communication system comprises at least one wireless network such as a Wireless Local Area Network (WLAN). In one embodiment of the invention, the router is a wireless router.

In one embodiment of the invention, the communication system comprises at least one of a Global System of Mobile Communications (GSM) network and a Universal Mobile Telephone System (UMTS) network.

In one embodiment of the invention, the computer program is stored on a computer readable medium. The computer readable medium may be a removable memory card, magnetic disk, optical disk or magnetic tape.

The benefits of the invention are related to ease of network maintenance and improved fault tolerance. The system according to the invention does not need a pre-specified route aggregation solution. However it can be used, if specified. The system builds the local-optimal solution by using the suggested method. The second part of the proposed method enlarges route aggregates by using information received via peer-to-peer communication with other routers, which also perform the automatic route aggregation. As a result, the method decreases network maintenance cost and improves quality of service provided to the end users. It allows to achieve the close to optimal route aggregation, while saves a lot of network administration time, protects against possible configuration errors and allows fast reacting to changes in the network topology.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a block diagram, which illustrates a communication system supporting the Classless Inter-Domain Routing (CIDR) in prior art;

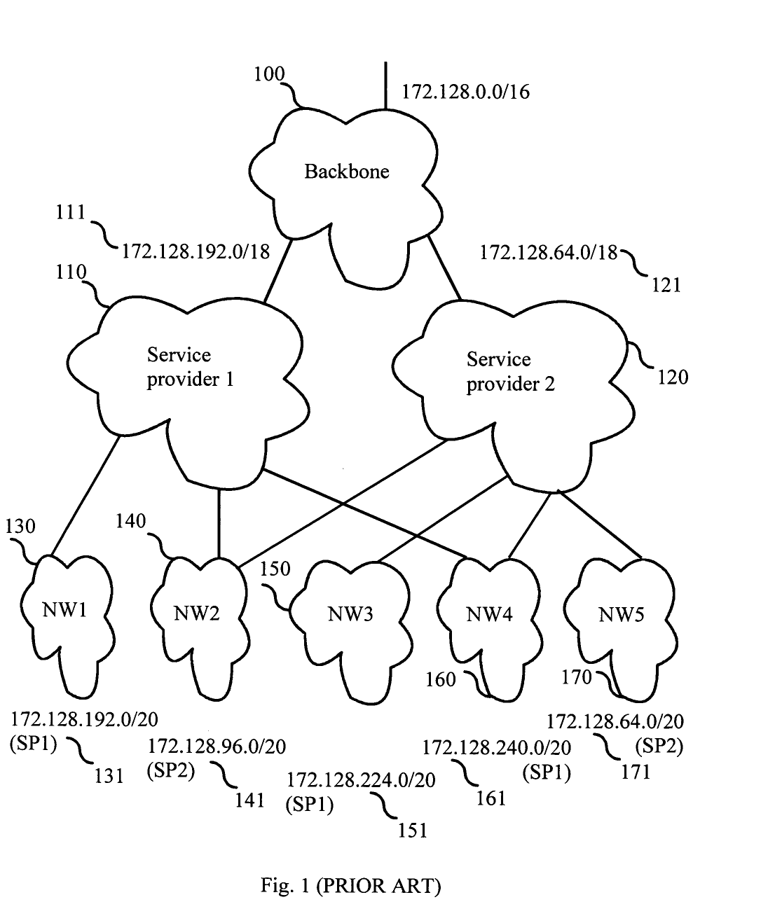

FIG. 2 is a table, which lists the IP addresses and network masks for the different networks illustrated in FIG. 1 in prior art;

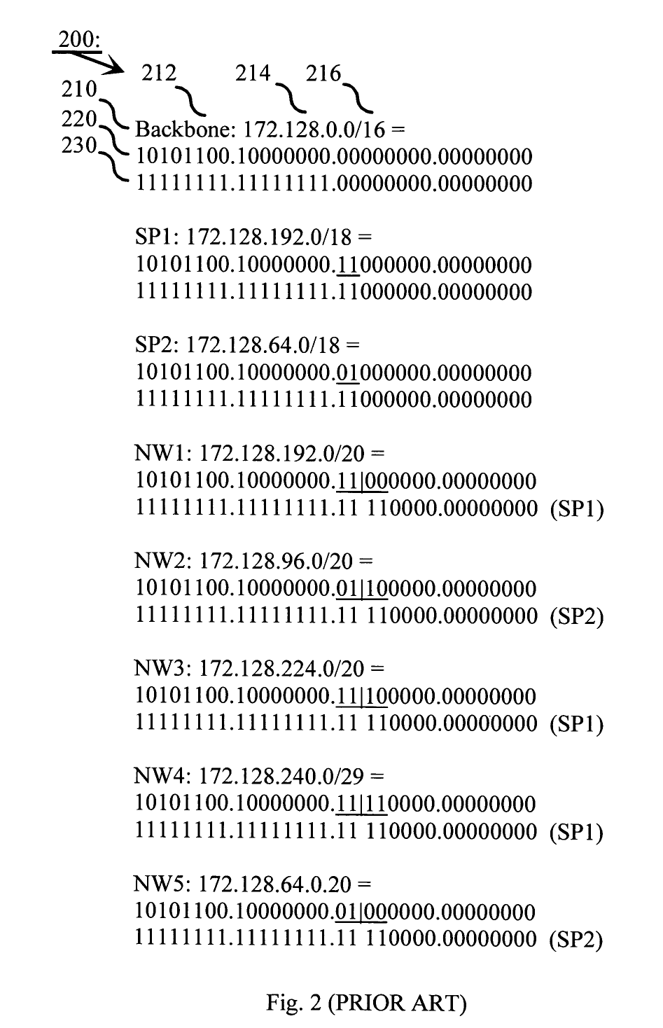

FIG. 3 is a block diagram, which illustrates an Autonomous System executing the Open Shortest Path First (OSPF) v2 protocol in prior art;

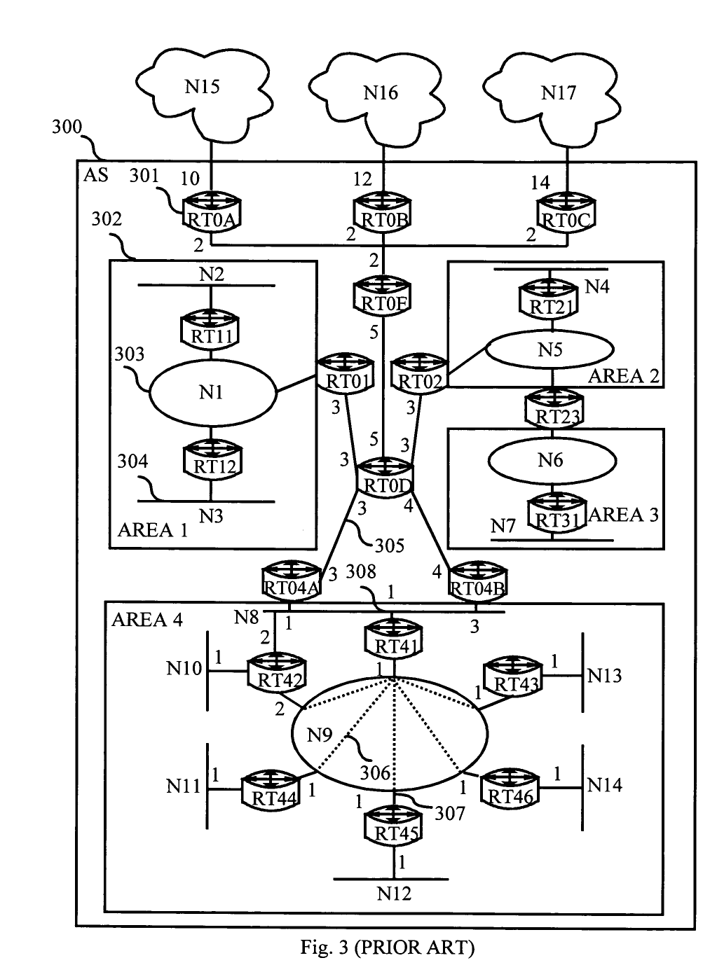

FIG. 4A is a block diagram illustrating a communication system, which comprises an Open Shortest Path First (OSPF) stub area and the area 0, in one embodiment of the invention;

FIG. 4B is a table listing the networks, the IP address and network mask pairs identifying the networks, and the number of hosts in each network in one embodiment of the invention;

FIG. 5 is a stepwise illustration of the results from the execution of the method for automatic route aggregation on the stub area of FIG. 4A, in one embodiment of the invention;

FIG. 6A is a flow chart illustrating a first part of the method for automatic route aggregation in one embodiment of the invention;

FIG. 6B is a flow chart illustrating a second part of the method for automatic route aggregation in one embodiment of the invention;

FIG. 7 is a flow chart illustrating a method for the calculation of the most specific route aggregate in one embodiment of the invention;

FIG. 8 is a block diagram illustrating the flow of link state advertisements in the stub area of FIG. 4A when the method for automatic route aggregation is executed in the stub area in one embodiment of the invention;

FIG. 9 is a block diagram illustrating a network, in which the method for automatic route aggregation is executed, in one embodiment of the invention; and

FIG. 10 is a block diagram illustrating a router implementing the method for automatic route aggregation in one embodiment of the invention.

### DETAILED DESCRIPTION OF THE EMBODIMENTS

Reference will now be made in detail to the embodiments of the present invention, examples of which are illustrated in the accompanying drawings.

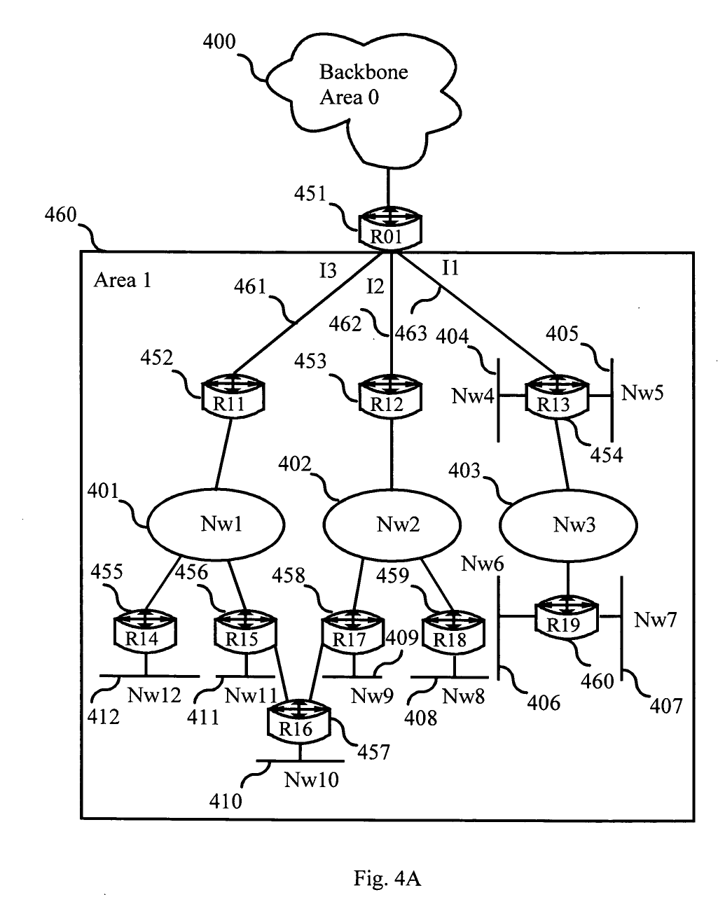

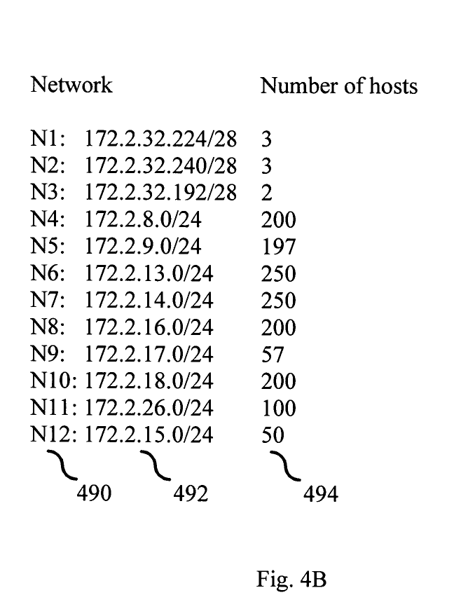

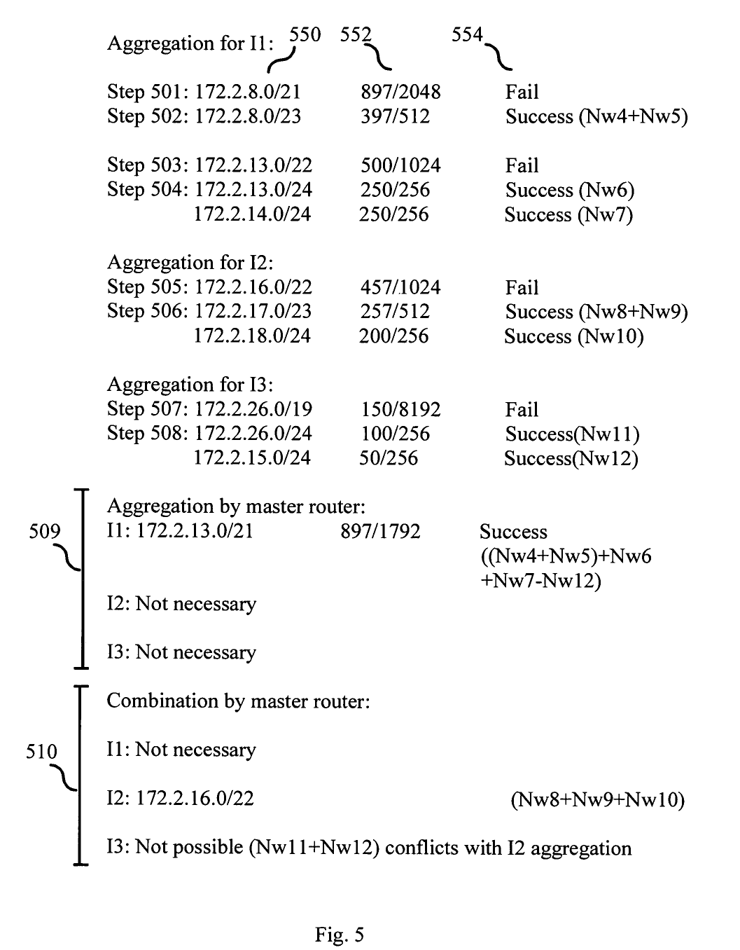

FIG. 4A is a block diagram illustrating a communication system, which comprises an Open Shortest Path First (OSPF) stub area and the area 0, in one embodiment of the invention. The communication system is comprised in an autonomous system (not shown). In FIG. 4A there are shown only two areas, namely the OSPF backbone 400 that is always numbered as area 0, and a second area 460, the number of which is 1 in this case. There may also be other areas, but they are not shown in this particular case. There is an area border router 451, which attaches to areas 400 and 460, numbered as 0 and 1 in OSPF, respectively. Area 460 comprises point-to-point networks 461, 462 and 463 by means of which router 451 is connected to routers 452, 453 and 454. The interfaces from router 451 to area 460 via point-to-point networks 461, 462 and 463 are also designated as I3, I2 and I1, respectively, for the purpose of illustration in subsequent FIGS. 4B and 5. Routers 452, 453 and 454 have interfaces to transit networks 401, 402 and 403, respectively. There are routers 455, 456, 457, 458 and 459, which connect to stub networks 412, 411, 410, 409 and 408, respectively. There is a router 460, which connects to both stub networks 406 and 407. Routers 455 and 456 have interfaces to transit network 401. Router 457 is connected via point-to-point networks to router 456 and 458. Routers 458 and 459 have interfaces to transit network 402. Router 460 has an interface to transit network 403. Router 454 has interfaces to stub networks 404 and 405. For the purpose of illustration in subsequent FIGS. 4B and 5 networks 401-412 are also designated as networks Nw1-Nw12, respectively. It is assumed for simplicity that each interface has associated with it the same cost, which equals to 1. Thus route cost to a given stub network is directly proportional to the number of router egress interfaces traversed on the path from an origin router within area 460 to the stub network. It should be noted that because of the fact that area 460 is configured as a stub area, the route cost from an origin router outside area 460 to any given network in area 460 is the same, which equals the longest distance from area border router 451 to a stub network within area 460. In FIG. 4A the cost is 4, which represents the path cost from router 451 to network 410. Area 460 is defined as a stub area in order to be able to perform automatic route aggregation by, for example, router 452 as a master router on behalf of routers 453 and 453. The final aggregate is made to the knowledge of router 451, which may advertise the aggregate in a summary-LSA to backbone 400. In one embodiment of the invention, routers 454-460 act as DHCP servers for stub networks 404-412. In one embodiment, there may be a separate DHCP server, which knows the IP addresses and network masks allocated for stub networks 404-412. In one embodiment of the invention the stub networks 404-412 each consist of at least one Ethernet segment. Ethernet segments may be connected using hubs and bridges.

FIG. 4B is a table listing the networks, the IP address and network mask pairs identifying the networks, and the number of hosts in each network in one embodiment of the invention. In FIG. 4B there is a column 490 listing the network names introduced in the description of FIG. 4A. The IP address and network mask pairs are provided in a column 492. The IP address is usually the IP address of the interface of the designated router for the network. The number of hosts connected to each listed network is provided in a column 494. The number of hosts may represent the actual number of hosts at the automatic route aggregation determination or an average number of hosts in the network during a given time interval. In one embodiment of the invention, the actual number of hosts may change frequently. Similarly, the ranges of the actual addresses allocated from the address range of a given stub network may be difficult to determine and may vary constantly. In one embodiment of the invention, a stub network is always considered to be full, that is, all the addresses in its address space are considered to be in use. A stub network is considered to be full for the purposes of the calculation of most specific route aggregates. In one embodiment of the invention an IP address and network mask pair is replaced with a pair consisting of an IPv6 prefix and a prefix length, that is, prefixes and prefix lengths are used instead of a IP addresses and masks for the purposes of the invention. The method is otherwise similar.

FIG. 5 is a stepwise illustration of the results from the execution of the method for automatic route aggregation on the stub area of FIG. 4A, in one embodiment of the invention. Before step 501 is executed the starting points for aggregation are the IP addresses and network mask pairs for each of the networks Nw1-Nw12, that is, the networks 401-412. The pairs are also called routes in the OSPF parlance. There is a column 510 illustrating the route aggregations each consisting of an IP address and a network mask, a column 512 illustrating the number of hosts versus the size of the address space indicated by the network mask and a column 514 indicating success or failure for the aggregation. The networks, the routes of which have been added to the aggregate, accompany the success indication in parenthesis.

At step 501 it is attempted to form an aggregate 172.2.8.0/21 comprising routes to networks Nw4, Nw5, Nw6 and Nw7. The number of hosts versus the size of the address space shows that the address space is not even half filled so the aggregation fails. At step 502 it is attempted to form an aggregate 172.2.8.0/23 comprising routes to networks Nw4 and Nw5, which succeeds due to the fact that the number of hosts versus the size of the address space shows that the address space is more than half filled. At step 503 it is attempted to form an aggregate 172.2.13.0/22 comprising routes to networks Nw6 and Nw7. The number of hosts versus the size of the address space shows that the address space is not more than half filled so the aggregation fails. At step 504 it is attempted to form aggregates 172.2.13.0/24 and 172.2.14.0/24 comprising routes to networks Nw6 and Nw7, respectively, which succeed due to the fact that the number of hosts versus the size of the address space shows that the address space is more than half filled. It should be noted that since Nw6 and Nw7 are broadcast stub networks, the performing more precise aggregations is not necessary even though the networks were not more than half filled.

At step 505 it is attempted to form an aggregate 172.2.16.0/22 comprising routes to networks Nw8, Nw9 and Nw7. Two least significant bits in third byte from the left in the IP address belong to the address space together with the fourth byte from the left, which yields altogether 4*256=1024 addresses. The number of hosts versus the size of the address space shows that the address space is not more than half filled (457/1024) so the aggregation fails. At step 506 it is attempted to form an aggregate 172.2.17.0/23 comprising routes to networks Nw8 and Nw9, which succeeds due to the fact that the number of hosts versus the size of the address space (257/512) shows that the address space is more than half filled. At step 506 it is also attempted to form aggregate 172.2.18.0/24 consisting of route to network Nw10, which succeeds due to the fact that the number of hosts versus the size of the address space (200/256) shows that the address space is more than half filled genuinely.

At step 507 it is attempted to form an aggregate 172.2.26.0/19 comprising routes to networks Nw11 and Nw12. Five least significant bits in third byte from the left in the IP address belong to the address space together with the fourth byte from the left, which yields altogether 32*256=8192 addresses. The number of hosts reachable via interface I3 versus the size of the address space shows that the address space is far from being more than half filled (150/8192) so the aggregation fails. Actually, aggregate 172.2.26.0/19 would have comprised all networks from Nw1 to Nw12 listed in column 490 of FIG. 4B. It should be noted that overlapping aggregations are dealt with in the second phase of the algorithm, which is performed by a master router based on the routers associated with each interface. The network masks are defined for the more specific routes. Recall that in OSPF routing is performed on longest match basis by inspecting the network masks for overlapping address spaces. At step 508 it is attempted to form aggregates 172.2.26.0/24 and 172.2.15.0/24 comprising routes to networks Nw6 and Nw7, respectively, which succeed due to the fact that the address spaces 172.2.26.0/24 and 172.2.15.0/24 belong to the individual stub networks Nw11 and Nw12, respectively. The number of hosts does not count, since there is no possibility to extend the network mask without considering individual hosts in a broadcast network. The actual address ranges may vary frequently. Hosts with the IP addresses forming a defacto upper or lower end of a given address range may constantly leave or enter the network.

At step 509 the aggregation algorithm of gradually increasing the network mask length is repeated in a master router for each interface I1, I2 and I3 connecting router 451 to area 460. The aggregation algorithm is able to diminish address space sizes by subtracting from the address space the more specific routes belonging to that address space. Due to the subtraction it is possible to form new more than half filled aggregates. The aggregation algorithm requires that each subordinate router adjacent to the area border router provide information on the candidate aggregates formed by them to a master router. The master router may be the area border router or one of the subordinate routers directly adjacent to the area border router. Pertaining to I1, master router forms an aggregate 172.2.13.0/21 comprising candidate route aggregate for networks Nw4 and Nw5, and candidate route aggregates to networks Nw6 and Nw7. Router 454 calculated these candidate route aggregates. From the aggregate 172.2.13.0/21 is taken away the route for Nw12, which has a more specific IP address and mask pair. Thus the actual address size space of aggregate 172.2.13.0/21 for interface I1 is 1792. Thus, the number of hosts versus the size of the address space (897/1792) shows that the address space is more than half filled. Thus aggregate 172.2.13.0/21 is the most specific route aggregate for interface I1. Pertaining to I2, there is no need to repeat the aggregation, since there are no more specific routes that could be excluded from the candidate aggregates for I2 calculated in router 453. In other words, it is not possible to reduce the address space size pointing to interface I2 by removing the address spaces of more specific routes pointing to other interfaces. Similarly, pertaining to I3, there is no need to repeat the aggregation, since there are no more specific routes that could be excluded from the candidate aggregates for I3.

At step 510 master router starts combining the aggregates formed in master router at step 509. At the combination step it is not necessary to have most specific route aggregates that are more than half filled. Instead, the utilization level is not considered at the combination step. At the combination step it is checked that the combination of most specific route aggregates does not result to route aggregates that conflict with previously formed route aggregates. The combination is performed for each interface I1, I2 and I3. For I1, the combination is not necessary, since all address space pointing to interface I1 is already covered by the aggregate performed at step 509 for I1. For I2, the combination of route aggregates 172.2.17.0/23 for networks Nw8 and Nw9, and 172.2.18.0/24 for network Nw10 yields the combination 172.2.16.0/22 for networks Nw8, Nw9 and Nw10. For I3, the combination of route aggregates 172.2.26.0/24 and 172.2.15.0/24 for networks Nw11 and Nw12 is not possible, since it conflicts with the existing route aggregate for I2, namely route aggregate 172.2.16.0/22. This can be checked since the combination of aggregates 172.2.26.0/24 and 172.2.15.0/24, namely 172.2.0.0/19 has subsumed in it the route aggregate 172.2.16.0/22 formed for interface I2. Throughout FIG. 5 the minus sign in column 514 in front of a network name means that the address space of the network is cut away from the route aggregate. The plus sign indicates route aggregation between any aggregates or networks.

Thereupon, the resulting combined aggregates or uncombined aggregates are defined as routes to area 460 of FIG. 4A. Each route advertised in a summary-LSA to backbone 400 has a uniform cost. Thus each combined aggregate comprising at least two aggregates has a uniform cost. Similarly, each uncombined aggregate has a uniform cost. The uniform cost is set, for example, to be the summed cost of the path to the most distant network in that aggregate or combination of aggregates. The distance is defined in terms of the costs associated with each interface that must be traversed to reach the network. It should be noted that even though aggregates or combined aggregates to area 460 are treated in a manner similar to stub areas in summary-LSAs emitted from area 460, it does not necessarily need to be treated as a stub area in summary-LSAs received to area 460 from backbone 400. In one embodiment of the invention, the routers 452, 453 and 454 are area border routers for area 460 and interface backbone 400 directly. In this embodiment combination of aggregates across interfaces is not allowed at the combination step 510 described in FIG. 5. The combination must only be performed within the scope of the route aggregates associated with a given single interface to area 460.

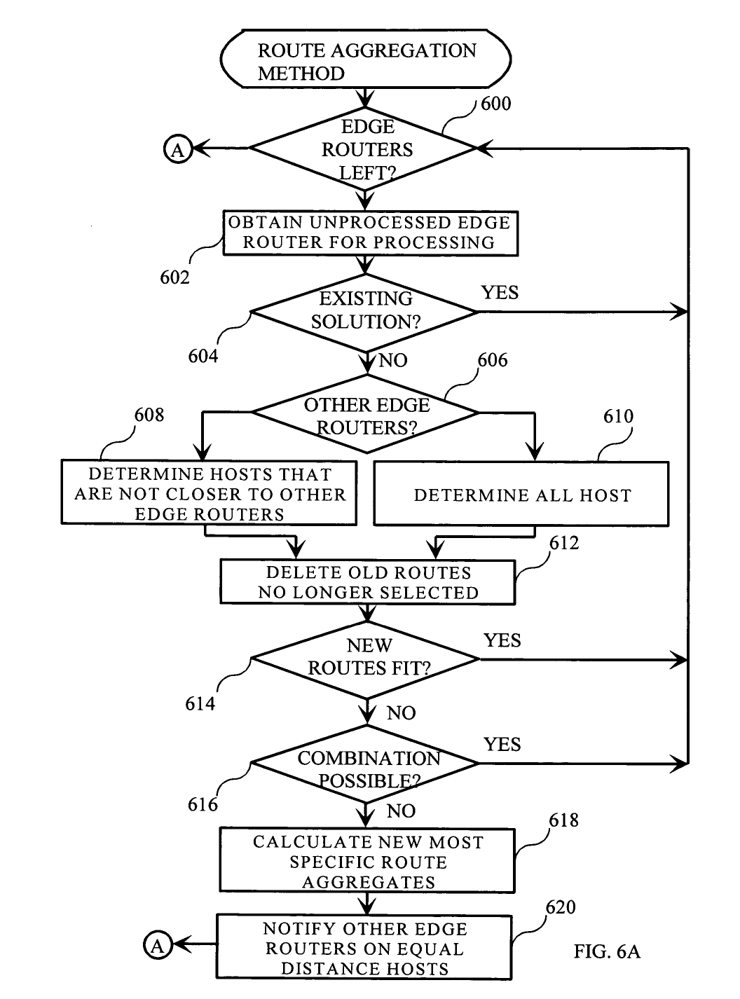

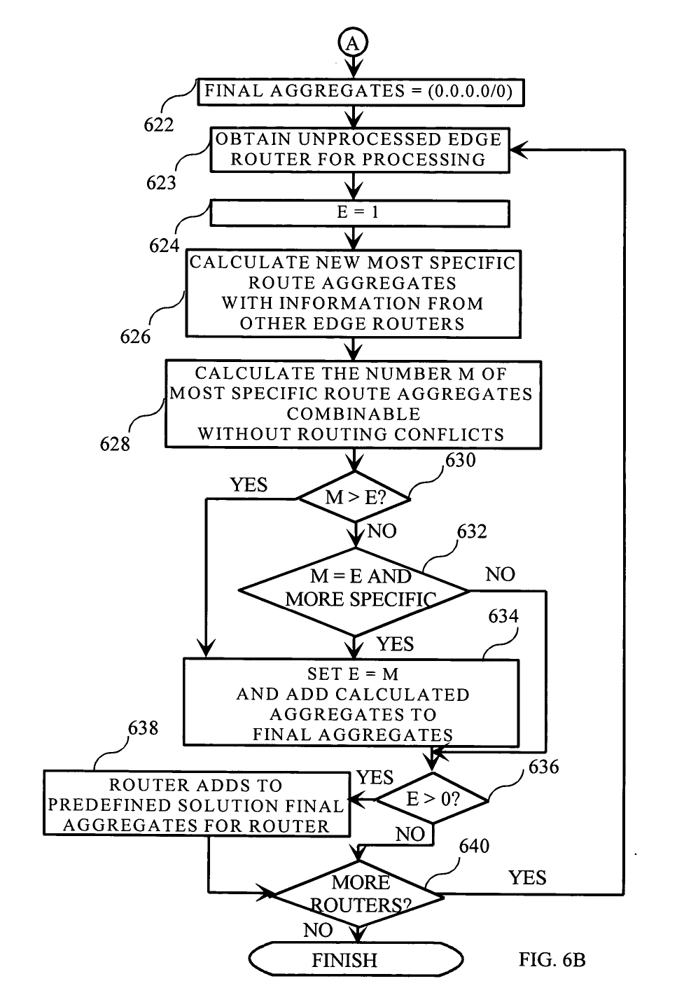

FIG. 6A is a flow chart illustrating a first part of the method for automatic route aggregation in one embodiment of the invention.

At step 600 it is checked if there are any unprocessed edge routers left for processing. If there are no unprocessed edge routers left, the method continues at step 622.

At step 602 an unprocessed edge router is obtained for processing, which involves the calculation of route aggregates for that router. In FIG. 4A routers 452, 453 and 454 are considered as edge routers. In one embodiment of the invention an edge router is an area border router. There may be at least one edge router. The obtaining of an edge router may involve that the aggregation algorithm is started in that edge router.

At step 604 it is checked if a route aggregation solution already exists for current edge router, if this is the case, the method continues for the part of a further edge router at step 600.

At step 606 it is checked if other edge routers exist. If other edge routers exist, the method continues at step 608. Otherwise, the method continues at step 608.

At step 608 those hosts or stub networks that are not closer to other edge routers are determined. For the consideration is taken any network entity or stub network with a known address or address space. The hosts and stub networks that are closest to current edge router are selected for further processing.

At step 610 all hosts and stub network are selected for further processing.

At step 612 old routes no longer selected are deleted from further processing.

At step 614 it is determined if new routes for newly emerged destinations fit the existing most specific route aggregation solution. If the newly emerged destinations fit, the method continues at step 600.

At step 616 it is determined if it is possible to build a new most specific route aggregate based on the combination of route aggregates previously defined and the routes to the newly emerged destinations. If the combination is possible it is performed and the method continues at step 600.

At step 618 the new most specific route aggregates are calculated for the edge router. For a given edge router, the aggregations for one of the interfaces I1, I2 and I3 illustrated in FIG. 5 in steps 501-504, 505-506 and 507-508, respectively, correspond to this step.

At step 620 other edge routers are notified of equal distance hosts. Depending on, for example, the comparison of router identifiers or a priority, the edge router that should keep the hosts is determined.

FIG. 6B is a flow chart illustrating a second part of the method for automatic route aggregation in one embodiment of the invention. The second part of the method is performed in a master router among the edge routers. The second part of the method is aimed in decreasing the number of route aggregates advertised to an upper level network. Before step 622 the master router has obtained the candidate route aggregates calculated by each edge router on its own. The candidate route aggregates are received to master router from the other edge routers.

At step 622 the final aggregates list is set to consist of 0.0.0.0/0, which is the default OSPF route that is used in the absence of actual non-trivial routes.

At step 623 an unprocessed edge router is obtained for processing. It is assumed that there exists at least one unprocessed edge router. Otherwise, the method should finish immediately (not shown).

At step 624 a variable E is set to 1.

At step 626 new most specific route aggregates are calculated with the candidate route aggregates from the current edge router and the candidate route aggregates from the other edge routers. In the calculation the more specific routes associated with the other edge routers are subtracted from the address space of the route aggregate of the current router. This is the difference compared to the similar calculation performed in the edge routers individually.

At step 628 the master router calculates the number M of most specific route aggregates that may be combined without creating routing conflicts.

At step 630 it is checked if M>E. If the condition is true, the method continues at step 634. If the condition is false, the method continues at step 632.

At step 632 it is checked if M=E and any of the calculated route aggregates has a more specific network mask than any of the aggregates in the final aggregates list. If the condition is true, the method continues at step 634. If the condition is false, the method continues at step 636.

At step 634 the variable E is set to M and final aggregates list is appended with the calculated and combined most specific route aggregates.

At step 636 it is checked if E>0. If the condition is true, the method continues at step 638. If the condition is false, the method continues at step 640.

At step 638 the master router adds to the predefined route aggregation solution the route aggregates from the final aggregate list that are associated with the current edge router.

At step 640 it is checked if there are more edge routers that are unprocessed. If there are more edge routers unprocessed, the method continues at step 622. Otherwise, the method is finished.

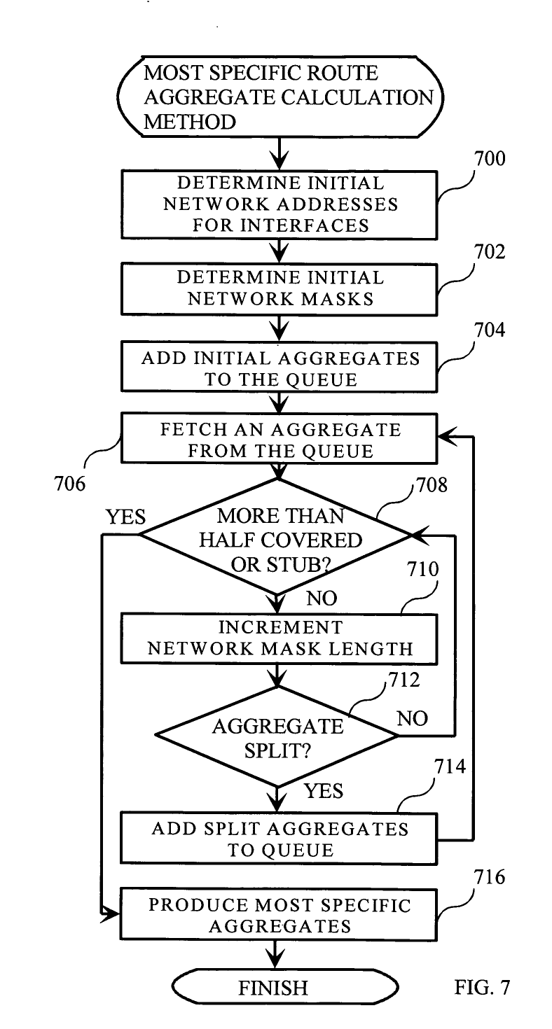

FIG. 7 is a flow chart illustrating a method for the calculation of the most specific route aggregate, in one embodiment of the invention.

At step 700 initial network addresses are determined for the interfaces to networks that are included in the calculation of the most specific route aggregate solution. In case of a multi-router network, the interface address is the interface address of the designated router.

At step 702 an initial network mask is determined. The initial network mask should comprise all interface addresses for the networks included in the calculation.

At step 704 an initial aggregate is added to a queue of aggregates.

At step 706 an aggregate is fetched from the queue.

At step 708 it is checked if more than half of the addresses included in the aggregate address space are in use or whether it is not possible to increment the network mask length by entering an address space allocated for a stub network. If the condition is true, the method continues at step 716. Otherwise, the method continues at step 710. By the network mask length is meant the number of “1” bits in front of the mask. The trailing bits are all “0” bits.

At step 710 the network mask length is incremented by 1.

At step 712 it is checked if the current aggregate should be split. This means that there are destination networks, which are no longer be covered by the network mask in its new length. If the aggregate must be split, the method continues at step 714. Otherwise, the method continues at step 710.

At step 714 the aggregate is split into two aggregates, which are added to the queue of aggregates. In practice, the aggregates may have already reduced to individual stub networks.

At step 716 the route aggregates in the queue of route aggregates are taken and produced as the calculated most specific route aggregates.

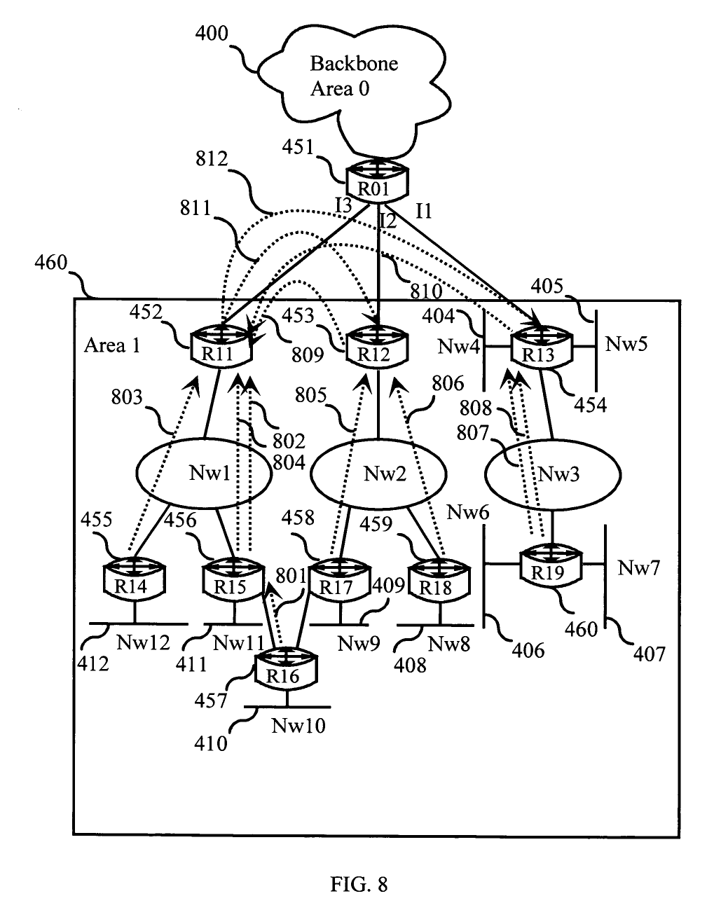

FIG. 8 is a block diagram illustrating the flow of link state advertisements in the stub area of FIG. 4A when the method for automatic route aggregation is executed in the stub area in one embodiment of the invention. The difference compared to FIG. 4A is that router 451 is now defined to be a router in the backbone 400 and routers 452, 453 and 454 are area border routers.

In the first stage of execution, stub networks from Nw4 to Nw12 cause network-LSAs to be flooded towards their respective area border routers. Similarly, routers in area 460 originate router-LSAs, which are flooded between adjacent routers. Arrows 801-808 illustrate the fact that area border routers 452, 453 and 454 learn the address spaces of their respective subordinate networks 406-412 via LSAs received from routers 455-460. The LSAs are either network-LSAs or router-LSAs. Router 454 knows directly the address spaces of networks 404 and 405. Thereupon, routers 452, 453 and 454 execute the most specific route aggregate calculation as illustrated in FIGS. 6A and 7. The result is the route aggregations as illustrated in FIG. 5 before step 509. It is assumed that router 452 is the master router. The route aggregation performed by routers 454, 453 and 452 are illustrated in FIG. 5 as aggregations for I3, I2 and I1, respectively.

As illustrated with arrows 809 and 810, routers 453 and 454 indicate their route aggregations to router 452, respectively. Router 452 acts as the master router. The master router performs most specific route aggregation calculation and aggregate combination as illustrated in FIGS. 6B and 7. Router 452 returns the responses comprising the route aggregation and combination results to routers 453 and 454 as illustrated with arrows 811 and 812, respectively. The route aggregation indication messages corresponding to arrows 809 and 810 may be sent to router 452 via router 451. Similarly, the result messages corresponding to arrows 811 and 812 may be sent to router 452 via router 451. An indication or a result message is directly addresses to the interface addresses of the intended recipient within backbone 400. Thus, messages 809-812 do not require an adjacency relationship to have been established between routers 452-454.

In one embodiment of the invention, an adjacency relationship is established between area border routers that use the automatic route aggregation method of the invention. An adjacency relationship is established during the Hello protocol so that a Hello protocol packet originating from an area border router using the method has a special indicator, which tells that an adjacency relationship for the purpose of flooding route aggregation indication and result messages must be established between any neighboring router acting as an area border router for the same area, that is, area 460 in FIG. 8.

In one embodiment of the invention, the adjacency relationship, in other words, an adjacency association for exchanging the route aggregates and the results is established between area border routers 452, 453 and 454 using IP multicast performed in the backbone 400. Area border routers 452-454 send packets for the discovery of other area border routers connecting to the same area, that is area 460, addressed to a specific IP multicast address. Such a packet specifies the IP unicast address, a list of non-backbone area identifiers to the areas, to which the router connects, and other identifying information of the sending router, for example, router 453. Eventually, all area border routers connecting to the same area have been discovered though the mutual exchange of the multicast packets. Thereupon, a master router is elected among the area border routers, for example, based on a priority or an ordering of router identifiers. As the master router has been elected, the exchange of the route aggregates and the results may be performed as illustrated with arrows 809-810 and 811-812, respectively. The messages 809-812 are routed, for example, via router 451 based on the destination IP unicast addresses. After the exchange of route aggregates and the results between the master router and the other area border routers has been performed, an event for the flooding of LSAs, for example, summary-LSAs to backbone 400 may be raised. The LSAs transmitted to backbone 400 provide to the flooding process of the backbone the up-to-date route aggregations and combinations as calculated by the master router pertaining to area 460, that is, area 1 in FIG. 8.

In one embodiment of the invention, the route aggregates and results may be exchanged as opaque-LSAs in OSPF. Opaque LSAs are defined in IETF RFC 2370. The messaging between routers 452,453 and 454 may also be implemented using Opaque LSAs flooded inside area 460.

Thereupon, routers 452, 453 and 454 may start advertising the route aggregations as routes in summary-LSAs to backbone 400.

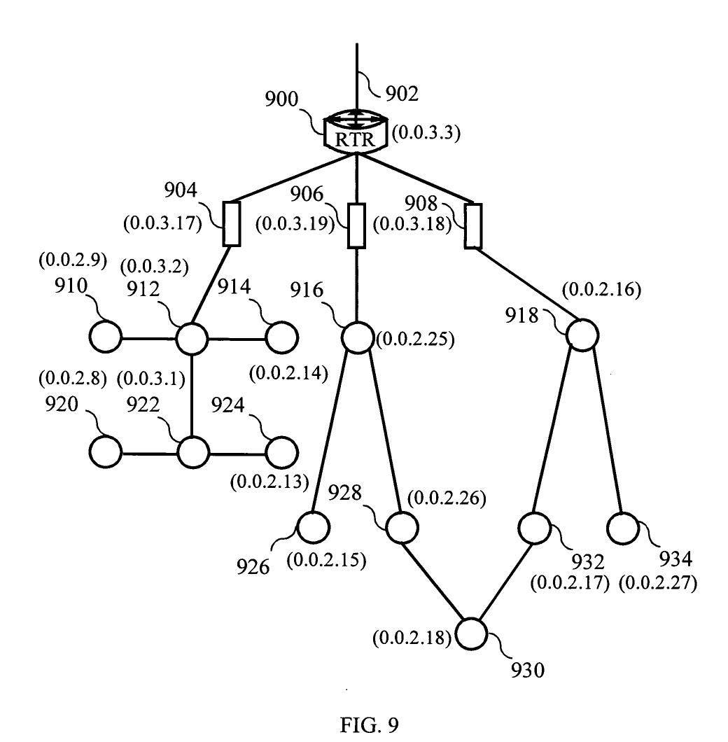

FIG. 9 is a block diagram illustrating a network, in which the method for automatic route aggregation is executed, in one embodiment of the invention. In FIG. 9 there is a router 900, which is connected to an arbitrary higher-level router via an interface 902. Router 900 has associated with it interfaces 904, 906 and 908. The interfaces may have associated with them respective edge routers (not shown). There are also nodes 910-934, which have their respective IP addresses shown in close proximity in FIG. 9. Similarly, the IP addresses of interfaces 904, 906 and 908 have their respective IP addresses shown in close proximity in FIG. 9. Nodes 910-934 are connected with point-to-point links as illustrated with solid lines. The point-to-point links may represent ATM virtual circuits or paths. The point-to-point links may also be point-to-point radio connections. The metric, in other words the cost is the same for all links, for example 1.

The upper level network consists of one router 0.0.3.3 (900). The upper level network is connected to two lower level networks, the first lower level network is connected via interface 0.0.3.17 (904), and the second is connected via interfaces 0.0.3.18 (908) and 0.0.3.19 (906). After initialization, each external interface introduces itself to all known edge routers. For, example edge router with interface 0.0.3.19 sends the introduction opaque LSAs to the edge routers with interfaces 0.0.3.17 and 0.0.3.18. The LSA associates external interface 0.0.3.19 with the upper level network edge router, so that the owner of 0.0.3.18 would know that address 0.0.3.19 belongs to another edge router.

Lets assume that interfaces “wake up” in the order of address ID increase, and the first interface knows information only about addresses of the upper level network, the second interface in addition knows aggregates produced by the first one and so on. Then, for interface 0.0.3.17 the most specific route aggregation algorithm works as follows:

1) Lets assume that there is no predefined route aggregation solution.

2) The interface receives advertisements from hosts: 0.0.2.8, 0.0.2.9, 0.0.2.13, 0.0.2.14, 0.0.3.2, and 0.0.3.3. That list does not contain addresses that belong to the other edge routers. All host addresses are selected as a target for aggregation.

3) As it is a first execution of the algorithm—all selected addresses should be used in calculation of the most specific aggregate routes:

a) First candidate is to present all 6 addresses by one aggregate 0.0.2.0/23, however 6 addresses cover much less than half of the actual coverage address space of this aggregate.

b) The aggregate for addresses 0.0.2.8, 0.0.2.9, 0.0.2.13, and 0.0.2.14 is 0.0.2.8/29. Actual coverage address space of this address is 8 and source addresses cover only half of that space (should be more than half), so that aggregate also cannot be accepted.

c) Addresses 0.0.2.8 and 0.0.2.9 can be aggregated to address 0.0.2.8/31, as they cover whole space of the aggregate.

d) The aggregate for addresses 0.0.2.13 and 0.0.2.14 is 0.0.2.12/30. Actual coverage address space of this address is 4 and source addresses cover only half of that space, so this aggregation cannot be accepted, and these addresses should be advertised independently.

e) Addresses 0.0.3.1 and 0.0.3.2 can be aggregated to address 0.0.3.0/30, as the size of actual coverage address space for this aggregate is 3 (full aggregate space size 4-1, the size of more specific route 0.0.3.3/32) and the source addresses represent 2 addresses of that space.

4) LSAs of the following aggregates: 0.0.2.8/31, 0.0.2.13/32, 0.0.2.14/32, and 0.0.3.0/30 are advertised to the upper level network.

For interface 0.0.3.18 the algorithm does following:

1) The interface received advertisements from hosts: 0.0.2.27, 0.0.2.16, 0.0.2.17, 0.0.2.18, 0.0.2.26, 0.0.2.25, 0.0.2.15, and 0.0.3.19. That list contains address 0.0.3.19 that belongs to another edge router. Analysis of the lower level network link state database shows that hosts 0.0.2.27, 0.0.2.16, and 0.0.2.17 are closer to the current interface, and host 0.0.2.18 has equal distances to the current interface and interface 0.0.3.19. The host addresses 0.0.2.27, 0.0.2.16, 0.0.2.17, and 0.0.2.18 (with the special mark) are selected as a target for aggregation.

2) As it is a first execution of the algorithm—all selected addresses should be used in calculation of the most specific route aggregates:

a) First candidate is to present all 4 addresses by one aggregate 0.0.2.16/28, however 4 addresses cover much less than half of the actual coverage address space of this aggregate.

b) The aggregate for addresses 0.0.2.16, 0.0.2.17, and 0.0.2.18 is 0.0.2.16/30. Actual coverage address space of this address is 4 and source addresses cover 3 addresses. As the aggregate include specially marked address, the algorithm generates an opaque LSA, which informs edge router 0.0.3.19 that address 0.0.2.18 is already included into aggregate by the current edge router.

3) LSAs of the following aggregates: 0.0.2.16/30 and 0.0.2.27/32 are advertised to the upper level network.

For interface 0.0.3.19 the algorithm works as follows:

1) The interface received advertisements from hosts: 0.0.2.15, 0.0.2.25, 0.0.2.26, 0.0.2.18, 0.0.2.17, 0.0.2.16, 0.0.2.27, and 0.0.3.19. That list contains address 0.0.3.18 that belongs to another edge route. Analysis of the lower level network link state database shows that hosts 0.0.2.15, 0.0.2.25, and 0.0.2.26 are closer to the current interface. Host 0.0.2.18 has equal distances to the current interface and interface 0.0.3.19, but that address is already aggregated by 0.0.3.19. The host addresses 0.0.2.15, 0.0.2.25, and 0.0.2.26 are selected as a target for aggregation.

2) As it is a first execution of the algorithm—all selected addresses should be used in calculation of the most specific aggregate routes:

a) First candidate is to present all 3 addresses by one aggregate 0.0.2.16/28, however 3 addresses cover much less than half of the actual coverage address space of this aggregate.

b) The aggregate for addresses 0.0.2.25 and 0.0.2.26 is 0.0.2.24/30. Actual coverage address space of this aggregate is 3 (full aggregate space size 4-1, sizes of more specific route 0.0.2.27/32 advertised by 0.0.3.18) and the source addresses represent 2 addresses of that space.

3) LSAs of the following aggregates: 0.0.2.24/30 and 0.0.2.15/32 are advertised to the upper level network.

So after the first execution of the algorithm on all edge routers, the upper level network has the following aggregate addresses of the lower level networks: 0.0.2.16/30, 0.0.2.24/30, 0.0.2.8/31, 0.0.2.13/32, 0.0.2.14/32, 0.0.2.15/32, 0.0.2.27/32, and 0.0.3.0/30.

Let us assume that the edge router with interface 0.0.3.17 is a master. Then, in the middle of LSA regeneration interval it executes the aggregates enlargement procedure, which does following:

1) Enlargement coefficient=1; Enlargement aggregate=0.0.0.0/0; selected edge router=NULL.

2) Edge router with interface 0.0.3.17 advertised 4 route aggregates, so it is a first candidate to check whether enlargement is possible:

a) Router 0.0.3.17 tries to build a new more specific route aggregates as a combination of the previous: Addresses 0.0.2.13 and 0.0.2.14 and 0.0.2.8/31 can be aggregated to 0.0.2.8/29, as the actual coverage address space of this aggregate is 7 (full aggregate space size 8-1, size of more specific route 0.0.2.15/32 advertised by 0.0.3.19) and the source addresses represent 4 addresses from that space.

b) The maximum number of most specific route aggregates that can be combined is 2, as combination of addresses 0.0.2.8/29 and 0.0.3.0/30 into a single aggregate 0.0.2.0/23 will not create routing conflicts.

c) Enlargement coefficient=2; Enlargement aggregate=0.0.2.0/23; selected edge router=0.0.3.17.

d) For the other edge routers the maximum number of most specific route aggregates that can be combined is 1, so they do not change the result.

3) The Enlargement coefficient is greater than 1 and the selected edge router is the current master router, so for the current interface 0.0.3.17 the algorithm sets a value of the predefined route aggregation solution to 0.0.2.0/23.

So after the second execution of the route aggregation algorithm on edge router 0.0.3.17, the upper level network has the following aggregate of the lower level networks: 0.0.2.0/23, 0.0.2.16/30, 0.0.2.24/30, 0.0.2.15/32, 0.0.2.27/32, and 0.0.3.0/30, which give us the optimal route aggregation for the current lower level networks, when optimality of the inter-networks routing is taken into account.

Next is discussed one embodiment of the invention. The algorithms presented before illustrate one possible implementation of the proposed method for automatic route aggregation, the core idea is of which is distributed dynamic route aggregation by the network edge routers, which have an ability to exchange all required details on the peer-to-peer basis. The first set of generated route aggregates is rather conservative, but guaranties error free routing. If the network shows stable behavior over a certain time interval, the edge routers generates less conservative aggregates, which replace previously generated more specific aggregates, and in a relatively short time the method finds the network-wide optimal route aggregation.

By applying the developed route aggregation strategy, the edge router creates a local-optimal solution that is guarantied to be routing errors free. The local-optimal solution consists of the most specific route aggregates. The aggregate route is considered to be most specific if its actual covered address space is more than half filled by the corresponding source addresses, where the actual coverage address space is defined as the full aggregate space minus sizes of all more specific routes that are covered by this aggregate. The obtained local-optimal solution is rather conservative, so there is a space for further improvement.

In order to find the network-wide optimal solution the edge routers need an ability to exchange some signals and information. The communication procedure should not burden of storing that information in the interior routers of the upper level network. That can be done in several ways. For example, it is possible to use a separate protocol, which would allow each router to gather details from the others, and given the same information shared and algorithm used, each can calculate its own contribution to the network-wide optimal solution. Another way to distribute that information is by using features of the upper level network routing protocol. The Open Shortest Path First (OSPF) routing protocol contains internal mechanism of opaque Link State Advertisements (LSAs) that can be used for carrying the route aggregation source information and other technical data while maintaining compatibility with the original protocol. As in the case of separate protocol, the non-edge routers would be involved in passing the information, but would not process and store it. The most suitable solution for our purposes is to use the opaque LSA link-state type 10.

The only configuration information required by the suggested method is specification of the “external” interfaces. The method assumes that all route advertisements received from the external interfaces belong to the lower level network. These route advertisements form a set of source routes for further aggregation.

In order to achieve better flexibility, the method defines three classes of the source routes. To the first class belong static or non-negotiable routes. To that class, for example, belong routes to the multi-homed hosts and routes that are statically configured by the network administrator. These routes cannot be included into the generated route aggregates. Also if the network contains more specific routes that fit to the static class aggregate, such routes can be aggregated only to the fully loaded aggregates (for which the source routes fill the whole address space). The second class is formed by the routes, which are targets for a further negotiation between edge routers. Such routes cannot be included into aggregates without notifying other edge routers that have similar rights to that route. To that class, for example, belong routes to the hosts located on the edge between sub-networks served by different edge routers. To the third class belong addresses that can be aggregated by the given edge router. Note, that according to the definition of most specific route aggregate, the source addresses that form the aggregate route cannot belong to the areas covered by another more specific route.

Another requirement of the method is that one of the edge routers should act as a master. Role of the master edge router is to perform enlargement of the route aggregates, which cannot be classified as the most specific aggregates. As such enlargement might create routing conflict, so it can be performed only after negotiation between involved edge routers, and the master router coordinates the negotiations and makes the final decision. The master edge router can be defined by the network administrator (e.g. the most powerful router, router with smallest average load, etc.), otherwise the first edge router advertised itself to the upper level network is declared to be the master edge router.

Also the method can use predefined route aggregation solutions. The predefined route aggregation solution gives a clear guideline of what kind of route aggregation should be performed during the next cycle of route aggregation. The predefined solution can be a result of the aggregate enlargement decision taken by the master router, or it can be a solution specified by the network administrator. In order to have faster convergence, it is recommended to set the predefined route aggregation solution at the initialization of a new edge router, however it is not mandatory.

When the automatic route aggregation mechanism starts on a new edge router, it reads local interface configuration information, defines interfaces that are external and on which the route aggregation should be performed. Then the mechanism sends addresses of the external interfaces to all known edge routers in the network. That information is needed for making more efficient route aggregation in case when lower level network has multiple interfaces to the upper level network.

Next is described one embodiment of the invention. The first element of the automatic route aggregation mechanism is an algorithm that performs most specific aggregation of the new routes received by the edge router via the specified external interfaces. Here the new routes are defined as routes to the previously unknown destination and routes with the new value of the routing metric. In one embodiment of the invention, the algorithm is executed at the beginning of the LSA regeneration event, and is as follows:

1) Check whether there is a predefined route aggregation solution, if so, the algorithm takes that solution as the most specific route aggregate, set a value of the predefined route aggregation solution to NULL, and goes to 4.

2) Otherwise, it verifies if among new routes received via the specified external interfaces are routes to the other edge routers.

a) If so then the lower level network has multiple interfaces to the upper network, and the route aggregation has to be done only for the hosts that are closer (in terms of the lower network default routing metric) to that interface. The link state database (that is used for building routing tables in OSPF) allows the calculation of the tree of shortest paths from any point in the network (as the database is consistent on all network nodes). The router calculates shortest path trees from the point of view of all other edge router. By comparing the received trees to the local shortest path tree it defines which hosts are closer to it, and selects these hosts as a target for route aggregation. If the other edge routers have the same shortest distance to some hosts, and these routers did not previously notify that the routes to these hosts are parts of their aggregates, such hosts are also selected and specially marked, as they are target for further negotiation.

b) Otherwise the algorithm selects all new routes as a target for route aggregation.

3) The algorithm compares the selected routes with the routes selected during the previous execution of the algorithm. If the new list does not contain some routes from the previous list then these routes as well as the route aggregates that are built using not longer selected routes must be deleted. For the routes that are new comparing the old list, the following actions should be performed:

a) Verify if the new routes fit to the previously defined route aggregates, and the once that do fit should be assigned to the corresponding aggregates.

b) Verify whether it is possible to build the new most specific aggregate routes based on the combination of the previously defined aggregate routes and the new routes.

c) For the rest of selected routes, the edge router calculates the new most specific route aggregates. The algorithm guaranties that the most specific route aggregates will not create routing conflicts with the aggregates generated by the other edge routers, as it is possible to generate only one route aggregate which actual covered address space is more than half filled.

d) For the specially marked routes, which are included in some aggregates, the algorithm generates a notification opaque LSA (that contains a list of these routes) and send it to the edge routers, which have the same distance to the corresponding hosts. For the rest of specially marked routes, the router advertises only addresses of the hosts, which are not already advertised to the upper level network by the other edge router.

4) The produced most specific route aggregates are advertised to the upper level network.

The second procedure is aimed in decreasing number of route aggregates advertised to the upper level network, by calculating the network-wide route aggregates enlargement solution. It is executed on the master edge router in the middle of each LSA regeneration interval. The route aggregate enlargement procedure defines which of the most specific route aggregates can be combined together without creating routing conflicts, and it works as follows:

1) Set an enlargement coefficient to 1, an enlargement aggregate to 0.0.0.0/0, and a selected edge router to NULL.

2) For each active edge router (starting from the router that advertised maximum route aggregates), the algorithm checks if the number of advertised route aggregates is greater than the enlargement coefficient, and if so, reads from the routing database of upper level network, information about the aggregates advertised by that router, and do the following operation:

a) Try to build the new most specific route aggregates as a combination of the current aggregates, by using new information from the other edge routers and new routes advertised in the upper level network (that information might decrease size of the actual covered address space).

b) Calculate maximum number of most specific route aggregates owned by that router, which can be combined to a single aggregate without creating routing conflicts. If some new most specific aggregates were found on the previous step, they should be used in the calculation instead of the corresponding source routes.

c) If the calculated maximum number is greater than enlargement coefficient OR (the number is equal to the enlargement coefficient and greater than 1 AND the calculated route aggregate has more specific route mask than the mask of the enlargement aggregate) THEN set the enlargement coefficient equal to the calculated maximum number, set the enlargement aggregate to the calculated route aggregate, and set selected edge router to the currently processed edge router.

3) If the enlargement coefficient is greater than 1:

a) If the selected edge router is the current (master) edge router then the procedure sets a value of the predefined route aggregation solution equal to the calculated enlargement aggregate solution.

b) Otherwise procedure generates an opaque LSA packet that contains definition of the enlargement aggregate, and sends it to the selected edge router. When the edge router receives such opaque LSA, it sends a confirmation to the master edge router and sets a value of the predefined route aggregation solution to the received enlargement aggregate solution.

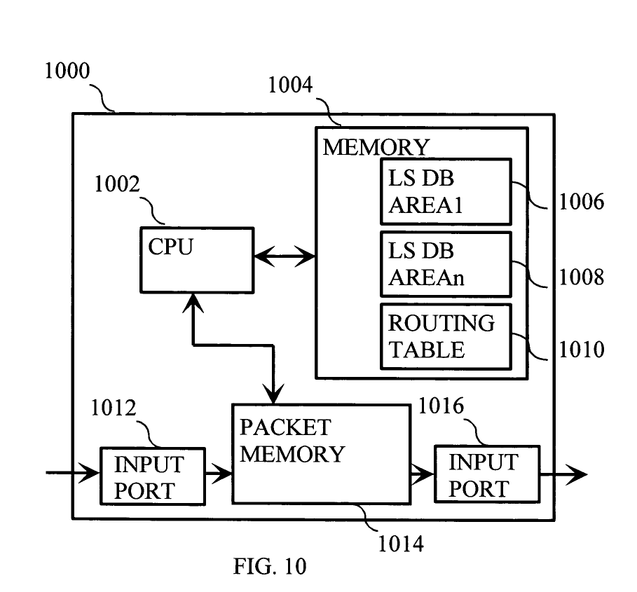

FIG. 10 is a block diagram illustrating a router implementing the method for the automatic aggregation of routes in one embodiment of the invention. In FIG. 10 there is a router 1000. The router comprises an input port 1012, an output port 1016, a packet memory 1014 and a CPU 1002. There is also a second memory 1004, which may be the same as packet memory 1014, but may also be separate. In memory 1004 there is stored a link state database for a first area 1006 and a link state database for a second area 1008. There is at least one link state database for each attached OSPF area. There is also a routing table 1010, which is used to determine the next hop for a given packet received at input port 1012 and stored in packet memory 1014. CPU 1002 uses a shortest path calculation according to OSPF to form the routing table. CPU 1002 also uses the algorithm of the invention to perform route aggregation in the forming of the routing table. The algorithms as illustrated in FIGS. 6A, 6B and 7 may be implemented as computer programs executed by CPU 1002. Similarly, CPU 1002 as illustrated in FIG. 8 may implement the processing of LSAs and other messaging between routers via computer programs executed. In memory 1004 may be stored a software program block, which comprises a protocol stack to perform OSPF message exchange or message exchange using any other protocol. In memory 1004 may be stored a software program block, which comprises the route aggregation algorithm of the invention and the OSPF routing table formation. The program blocks are executed by CPU 1002 in the form of processes or threads.

It is obvious to a person skilled in the art, that with the advancement of technology, the basic idea of the invention may be implemented in various ways. The invention and its embodiments are thus not limited to the examples described above; instead they may vary within the scope of the claims.

1. A method for automatic route aggregation in a communication system comprising at least a first area comprising at least one network, a second area comprising at least one network, a first edge router having an interface to both said first area and said second area, and a second edge router having an interface to both said first area and said second area, the method comprising:
obtaining information on at least two first routes each associated with a destination in said second area to said first edge router;
obtaining information on at least two second routes each associated with a destination in said second area to said second edge router;
determining in said first edge router at least one first route aggregate, which covers destinations in said at least two first routes and the address space utilization level of which reaches a predefined threshold;
determining in said second edge router at least one second route aggregate, which covers destinations in said at least two second routes and the address space utilization level of which reaches a predefined threshold;
obtaining in one of said first edge router and said second edge router information on both said at least one first route aggregate and said at least one second route aggregate;
determining in one of said first edge router and said second edge router at least one third route aggregate, the address space utilization level of which reaches a predefined threshold;
combining, in one of said first edge router and said second edge router, at least two route aggregates from said at least one first route aggregate, said at least one second route aggregate and said at least one third route aggregate to produce at least one fourth route aggregate; and
forming a routing table in said first area by means of information on said at least one fourth route aggregate.

2. The method according to claim 1, the method further comprising:
receiving a link-state advertisement in said first edge router on a first route;
transmitting information between said first edge router and said second edge router on said at least one fourth route aggregate; and
advertising information on said at least one fourth route aggregate in said first area.

3. The method according to claim 1, the method further comprising:
determining in one of said first edge router and said second edge router at least one third route aggregate, the address space utilization level of which reaches a predefined threshold by excluding from the address space of said at least one third route aggregate at least one route aggregate belonging to of said at least one first route aggregate and said at least one second route aggregate.

4. The method according to claim 1, the method further comprising:
indicating support for automatic route aggregation between said first edge router and said second edge router;
determining in said first edge router and said second edge router that they both have an interface to said second area;
establishing an adjacency relationship between said first edge router and said second edge router; and
exchanging information on at least one route aggregate between said first router and said second router over said adjacency connection.

5. The method according to claim 1, wherein said predefined threshold is more than half of the address space.

6. The method according to claim 1, wherein said communication system comprises a packet switched communication system.

7. The method according to claim 1, wherein said destinations and said route aggregates are specified with a network address and a network mask.

8. The method according to claim 1, wherein said communication system transmits Internet Protocol (IP) packets.

9. The method according to claim 1, wherein said second area comprises an Open Shortest Path First OSPF area.

10. The method according to claim 1, wherein said first area comprises an autonomous system different from the autonomous system to which said second area belongs.

11. The method according to claim 1, wherein said communication system comprises at least one wireless network.

12. A system comprising:
a first edge router configured to obtain information on at least two first routes each associated with a destination in a second area, to determine at least one first route aggregate, which covers destinations in said at least two first routes and the address space utilization level of which reaches a predefined threshold;
a second edge router configured to obtain information on at least two second routes each associated with a destination in a second area, to determine at least one second route aggregate, which covers destinations in said at least two second routes and the address space utilization level of which reaches a predefined threshold;
a master edge router configured to obtain information on both said at least one first route aggregate and said at least one second route aggregate, to determine at least one third route aggregate, the address space utilization level of which reaches a predefined threshold, to combine at least two route aggregates from said at least one first route aggregate, said at least one second route aggregate and said at least one third route aggregate to produce at least one fourth route aggregate; and to advertise in said first area information on said at least one fourth route aggregate.

13. The system according to claim 12, the system further comprising:
said first edge router configured to receive a link-state advertisement on a first route; and
said master router configured to transmit information to said first and said second edge router on said at least one fourth route aggregate.

14. The system according to claim 12, the system further comprising:
said master edge router configured to determine at least one third route aggregate, the address space utilization level of which reaches a predefined threshold by excluding from the address space of said at least one third route aggregate at least one route aggregate belonging to of said at least one first route aggregate and said at least one second route aggregate.

15. The system according to claim 12, the system further comprising:
said master router configured to indicate support for automatic route aggregation, to determine that said master router has an interface to said second area, to determine that said first edge router and said second edge router have an interface to said second area, to establish adjacency relationships from said master router to said first edge router and said second edge router and to exchange information on at least one route aggregate with said first edge router and said second edge router associated with said adjacency relationships;
said first edge router configured to determine that said first edge router has an interface to said second area, to indicate support for automatic route aggregation and that said first edge router has an interface to said second area to said master router, to establish an adjacency relationship with said master router and to exchange information on at least one route aggregate with said master router associated with said adjacency relationship; and
said second edge router configured to determine that said second edge router has an interface to said second area, to indicate support for automatic route aggregation and that said second edge router has an interface to said second area to said master router, to establish an adjacency relationship with said master router and to exchange information on at least one route aggregate with said master router associated with said adjacency relationship.

16. The system according to claim 12, wherein said predefined threshold is configured to be more than half of the address space.

17. The system according to claim 12, wherein said communication system comprises a packet switched communication system.

18. The system according to claim 12, wherein said destinations and said route aggregates are specified with a network address and a network mask.

19. The system according to claim 12, wherein said communication system transmits Internet Protocol (IP) packets.

20. The system according to claim 12, wherein said second area comprises an Open Shortest Path First OSPF area.

21. The system according to claim 12, wherein said first area comprises an autonomous system different from the autonomous system to which said second area belongs.

22. The system according to claim 12, wherein said communication system comprises at least one wireless network.

23. A router comprising:
an input port;
an output port;
a memory connected to said input port and said output port; and
a processor configured to obtain information on at least two first routes each associated with a destination in a second area, to determine at least one first route aggregate, which covers destinations in said at least two first routes and the address space utilization level of which reaches a predefined threshold, to obtain information on said at least one first route aggregate and at least one second route aggregate, to determine at least one third route aggregate, the address space utilization level of which reaches a predefined threshold, to combine at least two route aggregates from said at least one first route aggregate, said at least one second route aggregate and said at least one third route aggregate to produce at least one fourth route aggregate, and to advertise in a first area information on said at least one fourth route aggregate.

24. A computer program comprising code adapted to perform the following steps when executed on a data-processing system:
obtaining information on at least two first routes each associated with a destination in a second area;
determining at least one first route aggregate, which covers destinations in said at least two first routes and the address space utilization level of which reaches a predefined threshold;
obtaining information on said at least one first route aggregate and at least one second route aggregate;
determining at least one third route aggregate, the address space utilization level of which reaches a predefined threshold;
combining at least two route aggregates from said at least one first route aggregate, said at least one second route aggregate and said at least one third route aggregate to produce at least one fourth route aggregate; and
advertising in a first area information on said at least one fourth route aggregate.

25. The computer program according to claim 24, wherein said computer program is stored on a computer readable medium.

26. The computer program according to claim 25, wherein said computer readable medium is a removable memory card.

27. The computer program according to claim 25, wherein said computer readable medium is a magnetic or an optical disk.
